(19) United States
(12) Patent Application Publication
(10) Pub. No.: US 2022/0261764 A1
(43) Pub. Date: Aug. 18, 2022

(54) INFORMATION PROCESSING METHOD, INFORMATION PROCESSING DEVICE, AND PROGRAM

(71) Applicant: TOYOTA JIDOSHA KABUSHIKI KAISHA, Toyota-shi (JP)

(72) Inventor: Hideko Yamamoto, Toyota-shi (JP)

(73) Assignee: TOYOTA JIDOSHA KABUSHIKI KAISHA, Toyota-shi (JP)

(21) Appl. No.: 17/564,424

(22) Filed: Dec. 29, 2021

(30) Foreign Application Priority Data
Feb. 18, 2021 (JP) 2021-024463

(51) Int. Cl. G06Q 10/10; G06F 16/9535; G06F 16/9536; G06F 16/9538

(52) U.S. Cl. CPC G06Q 10/1053; G06F 16/9538; G06F 16/9536; G06F 16/9535

(57) ABSTRACT

An information processing method includes: receiving, from a user terminal of a first user, a disclosure request that is a request for disclosure of information about a plan of a predetermined activity to be hosted by the first user, and identification information on one or more second users who are designated by the first user from among a plurality of users as receivers of a request to participate in running the predetermined activity; disclosing the information about the plan of the predetermined activity on a first website; and sending a request to participate in running the predetermined activity to user terminals of the one or more second users.

### CROSS-REFERENCE TO RELATED APPLICATION

This application claims priority to Japanese Patent Application No. 2021-024463 filed on Feb. 18, 2021, incorporated herein by reference in its entirety.

### BACKGROUND

### 1. Technical Field

This disclosure relates to an information processing method, an information processing device, and a program.

### 2. Description of Related Art

There is a disclosed technology in which announcement information about holding an event is distributed to communication terminals of those who wish to receive such information, and a payment process or a process of securing a credit line is executed upon acquiring information on application for the event from communication terminals of participation applicants who wish to participate in the event (e.g., Japanese Unexamined Patent Application Publication No. 2018-206041).

### SUMMARY

Planning an event involves, for example, recruiting collaborators who run the event together in advance of planning, which sometimes raises the hurdle of planning an event.

An object of this disclosure is to provide an information processing method, an information processing device, and a program that can lower the psychological hurdle of planning an event.

One aspect of this disclosure is an information processing method including: receiving, from a user terminal of a first user, a disclosure request that is a request for disclosure of information about a plan of a predetermined activity to be hosted by the first user, and identification information on one or more second users who are designated by the first user from among a plurality of users as receivers of a request to participate in running the predetermined activity; disclosing the information about the plan of the predetermined activity on a first website; and sending a request to participate in running the predetermined activity to user terminals of the one or more second users.

Another aspect of this disclosure is an information processing device including a control unit that executes: receiving, from a user terminal of a first user, a disclosure request that is a request for disclosure of information about a plan of a predetermined activity to be hosted by the first user, and identification information on one or more second users who are designated by the first user from among a plurality of users as receivers of a request to participate in running the predetermined activity; disclosing the information about the plan of the predetermined activity on a first website; and sending a request to participate in running the predetermined activity to user terminals of the one or more second users.

Still another aspect of this disclosure is a program that causes a computer to execute: receiving an input of a disclosure request that is a request for disclosure of information about a plan of a predetermined activity to be hosted by a first user, and an input of designation of one or more second users among a plurality of users as receivers of a request to participate in running the predetermined activity; and sending the disclosure request and identification information on the one or more second users to a predetermined server, wherein the predetermined server executes: disclosing the information about the plan of the predetermined activity on a first website; and sending a request to participate in running the predetermined activity to user terminals of the one or more second users.

According to this disclosure, the psychological hurdle of planning an event can be lowered.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing one example of the system configuration of an event planning system according to a first embodiment;

FIG. 2 is one example of the hardware configurations of a center server and a user terminal;

FIG. 3 is a view showing one example of the functional configurations of the center server and the user terminal;

FIG. 4 is a table showing one example of information held in a user information database;

FIG. 5 is one example of information held in an event information database;

FIG. 6 is a chart showing one example of transition of a status of an event;

FIG. 7 is one example of a user registration screen of a user terminal;

FIG. 8 is one example of a profile screen of the user terminal;

FIG. 9 is one example of a favorite resource list display screen of the user terminal;

FIG. 10 is one example of an event registration screen of the user terminal;

FIG. 11 is one example of a user search screen of the user terminal;

FIG. 12 is one example of an event-running offer list screen of the user terminal;

FIG. 13 is one example of an event list screen of the user terminal;

FIG. 14 is one example of a flowchart of a process of the user terminal;

FIG. 15 is one example of a flowchart of a process of a center server;

FIG. 16 is one example of a flowchart of an event management process of the center server; and

FIG. 17 is one example of a sequence chart of a process in the event planning system from when an event is originally proposed until the event is determined to take place.

### DETAILED DESCRIPTION OF EMBODIMENTS

One aspect of this disclosure is an information processing method including: receiving, from a user terminal of a first user, a disclosure request that is a request for disclosure of information about a plan of a predetermined activity to be hosted by the first user, and identification information on one or more second users who are designated by the first user from among a plurality of users as receivers of a request to participate in running the predetermined activity; disclosing the information about the plan of the predetermined activity on a first website; and sending a request to participate in running the predetermined activity to user terminals of the one or more second users.

This information processing method is executed by an information processing device. The information processing device is a computer, such as a server. This server may be, for example, a web server. The information processing device includes a control unit, such as a processor, and this control unit executes the information processing method. Examples of the predetermined activity to be hosted by the first user include an event that is held with a predetermined number of people gathering at a predetermined place, an event distributed on the Web, and crowd-funding. Examples of such events include a dinner party, experiential gathering, counseling workshop, lecture, class, concert, and tour.

According to one aspect of this disclosure, when planning a predetermined activity, the first user designates second users who the first user wants to participate in running the activity together, and can thereby send a request of participation to the second users through the information processing device. Thus, the first user can request the second users to participate in the predetermined activity without directly accessing the second users, which can lower the psychological hurdle of planning the predetermined activity.

In one aspect of this disclosure, any user among the users may be able to be designated as one of the one or more second users. This means that the first user can request a second user to participate in the predetermined activity even when the first user and the second user are not personally acquainted with each other. Even when the first user has not built a relationship with the second user in advance, the first user can plan the predetermined activity by designating the second user as a candidate to participate in running the predetermined activity, and thus can plan the predetermined activity with a light heart. In addition, the possibility of requesting unacquainted people to participate in running an activity contributes to creating opportunities for meeting people.

The information processing method as one aspect of this disclosure may further include: holding, in a storage unit, resource information about each of the users as a piece of user information about the user; and disclosing the resource information about each of the users on the first website. In this case, the information about the plan of the predetermined activity may include at least one piece of the resource information connected with the first user. The resource information may include a place, an object, and a thing relating to interests and concerns of the user and to skills that the user is able to offer.

In one aspect of this disclosure, the predetermined activity is planned, disclosed, and held based on a place, an object, and a thing relating to interests and concerns of each user and to skills that the user can offer. Thus, through the predetermined activity, the user can run and execute the predetermined activity with those who have sympathized with the resource information relating to the predetermined activity. Since people participating in the predetermined activity are those who have sympathized with the resource information relating to the predetermined activity, the user can meet people with whom he or she has had no connection before and can thereby expand his or her own world.

In one aspect of this disclosure, the second user may be a user selected from a result of a search by a piece of resource information specified by the first user. Thus, a person to run the predetermined activity together can be selected from among people who sympathize with the resource information relating to the predetermined activity.

The information processing method as one aspect of this disclosure may further include: receiving, from a user terminal of a third user, a recording request that is a request for recording of first resource information disclosed about another user, and the first resource information; and recording, in the storage unit, user information on the third user and the first resource information so as to be connected with each other. Thus, the third user can collect and accumulate pieces of resource information on other users that have interested the third user. The accumulated pieces of resource information on other users may be used, for example, when the third user plans a predetermined activity, for reference in designating candidates who the third user wants to participate in running the predetermined activity.

The information processing method as one aspect of this disclosure may further include: determining that the plan of the predetermined activity is validated and making a disclosure to that effect, when, in response to the request to participate in running the predetermined activity, responses agreeing to participate are received from all the user terminals of the second users; and determining that the plan of the predetermined activity is invalidated and making a disclosure to that effect, when a response declining to participate is received from at least one of the user terminals of the second users. In one aspect of this disclosure, the plan of the predetermined activity is invalidated when at least one of the second users declines to participate in running the predetermined activity. In one aspect of this disclosure, therefore, it is easier for the second user to refuse to participate in running the predetermined activity than, for example, when the second user is requested to participate in running the predetermined activity after the plan is validated. Thus, the psychological hurdle of planning a predetermined activity can be lowered also for the second user.

The information processing method as one aspect of this disclosure may further include permitting exchange of messages between the user terminal of the first user and the user terminals of the one or more second users after the plan of the predetermined activity is validated. Thus, before the plan is validated, the first user who hosts the predetermined activity and the second users who are requested to participate in running the predetermined activity are prevented from interacting with each other, which, for example, makes it easier for the second users to refuse the request to participate in running the predetermined activity. Therefore, the psychological hurdle of planning a predetermined activity can be lowered.

The information processing method as one aspect of this disclosure may further include: for the disclosed plan of the predetermined activity, receiving, from a user terminal of a fourth user, a participation request that shows that the fourth user desires to participate as a staff member; and determining that the predetermined activity is to take place and making a disclosure to that effect, when the number of fourth users reaches a predetermined number, and determining that the predetermined activity is canceled and making a disclosure to that effect, when the number of the fourth users falls short of the predetermined number. In one aspect of this disclosure, whether the predetermined activity being planned is to take place is determined according to whether the number of fourth users has reached a predetermined number, regardless of whether a place to hold the activity, a budget, etc. are secured. Thus, for the predetermined activity to be determined to take place, the first user need not act to secure a place to hold the activity, a budget, etc.; instead, the first user can set out to secure a place, a budget, etc., for example, after the predetermined activity is determined to take place, i.e., after a sufficient number of participants have been recruited. Therefore, the psychological hurdle of planning an event can be lowered.

As another aspect, this disclosure can be identified as an application program installed in a user terminal. This program causes a computer to execute: receiving an input of a disclosure request that is a request for disclosure of information about a plan of a predetermined activity to be hosted by a first user, and an input of designation of one or more second users among a plurality of users as receivers of a request to participate in running the predetermined activity; and sending the disclosure request and identification information on the one or more second users to a predetermined server. The predetermined server executes the above-described information processing method. The computer that executes this program is a user terminal, such as a smartphone, a personal computer (PC), or a tablet terminal.

In the following, an embodiment of this disclosure will be described based on the drawings. The configuration of the following embodiment is an example, and this disclosure is not limited to this configuration of the embodiment.

### First Embodiment

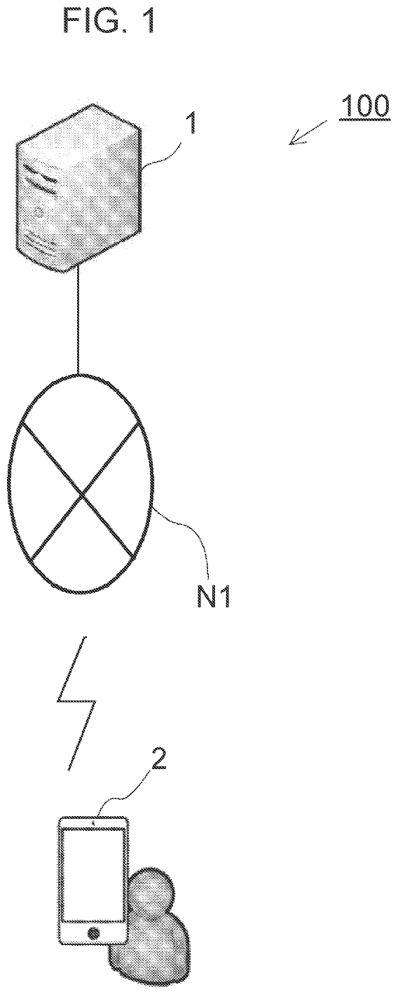

FIG. 1 is a view showing one example of the system configuration of an event planning system 100 according to a first embodiment. The event planning system 100 is a system that provides a social networking service (SNS) for planning of an event and recruiting staff and participants for the event. In the first embodiment, the event is an activity that is carried out with a predetermined number of people gathering at a predetermined place. Specific examples of events include a dinner party, experiential gathering, counseling workshop, lecture, class, concert, and tour. Further, the event may be one held on the Web.

The event planning system 100 is a system that discloses a place, thing, and object that interest or concern each user or that each user can offer, and supports users who sympathize with disclosed information in holding an event together. Hereinafter, the place, thing, and object that interest or concern each user or that each user can offer will be referred to as resources. A thing is intangible and is, for example, a phenomenon or an experience. An object is tangible, and examples of objects include also a person. In the event planning system 100, resources relating to a user and an event are disclosed, and searches for a user and an event are made using the disclosed resources as a clue. Thus, the event planning system 100 is a system aiming at connecting users with each other through the resources.

The event planning system 100 includes a center server 1 and a user terminal 2. While only one user terminal 2 is shown in FIG. 1, the event planning system 100 includes a plurality of user terminals.

The center server 1 and the user terminal 2 each connect to a network N1 and can communicate with each other through the network N1. The network N1 is, for example, the Internet.

In the user terminal 2, a client application program of the event planning system 100 is installed. When the user of the user terminal 2 hosts an event, for example, information about the event is input into the user terminal 2. Examples of the information about the event include the name of the event, a desired venue, a description summarizing the event, and information on resources relating to the event. Hereinafter, information about an event will be referred to as event information.

In the first embodiment, when inputting event information, the user can designate other users who the user wants to participate in running the event. A person who originally proposes an event will be hereinafter referred to as an originator user. Other users who are desired to participate in running an event will be hereinafter referred to as candidate event-running users. Designation of candidate event-running users is not limited, and any user registered in the event planning system 100 can be designated. The originator user is one example of the “first user.” The candidate event-running user is one example of the “second user.”

The user terminal 2 sends an event disclosure request to the center server 1. Upon receiving the event disclosure request from the user terminal 2, the center server 1 discloses the event information about the event on the website of the event planning system 100. When the event information is disclosed, recruitment of event-running users who run the event and supporters who help run the event is started. The event-running users are users who are involved in determining the time and place to hold the event and the contents of the event and in planning the proceedings of the event. The supporters are users who are not involved in planning but help receive and guide participants on the day of the event as staff. The supporter is one example of the “fourth user.” The website of the event planning system 100 is one example of the “first website.”

The center server 1 discloses the event information, and sends an event-running offer that is a request to participate in running the event to the user terminals 2 of the designated candidate event-running users. The candidate event-running users view the event information and determine whether to participate in running the event. In the first embodiment, when responses accepting the event-running offer have been received from the user terminals 2 of all the candidate event-running users, the plan of the event is validated and moves to the next phase. When a response declining the event-running offer is received from the user terminal 2 of at least one of the candidate event-running users, the plan of the event is invalidated and planning of the event ends. The candidate event-running users who have accepted the event-running offer join the running, and therefore will be hereinafter referred to as event-running users.

In the first embodiment, after the plan of the event is validated, the center server 1 permits, for example, exchange of messages to allow the originator user and the event-running users to interact with each other. Thereafter, meetings are held between the originator user and the event-running user to determine details of the event.

When a predetermined number of supporters for the event has been recruited, the center server 1 determines that the event is to take place. On the other hand, when the number of supporters has not reached the predetermined amount after a predetermined period has elapsed since validation of the event, the center server 1 determines that the event is canceled.

In the first embodiment, when planning an event, the user designates other users as candidate event-running users, and then the center server 1 sends an event-running offer to those candidate event-running users, thereby eliminating the need for the user to recruit collaborators in advance on his or her own. Therefore, the user can plan an event even in the absence of collaborators who run the event together, which can lower the psychological hurdle of planning an event.

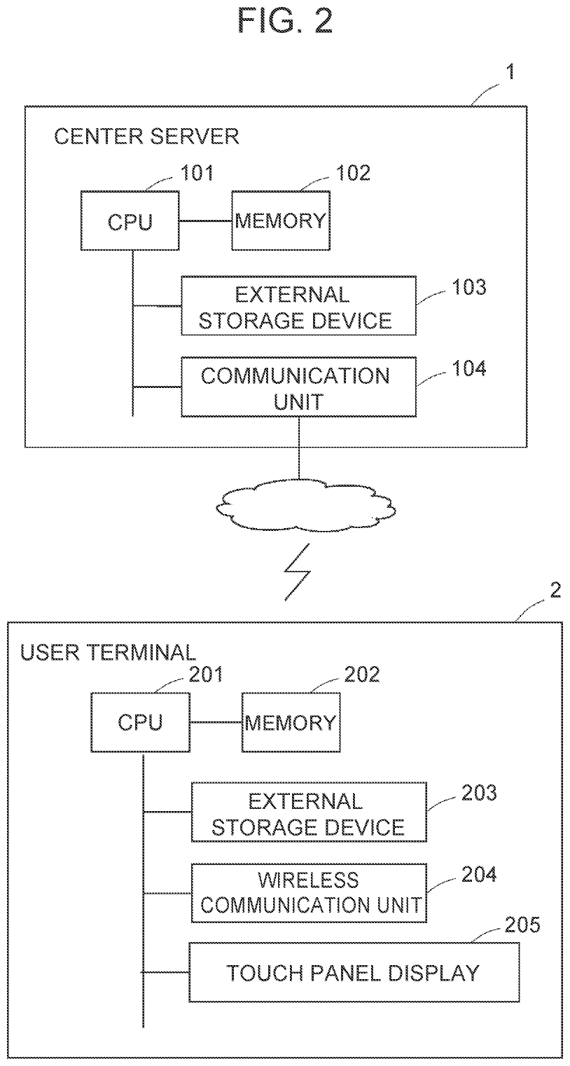

FIG. 2 is one example of the hardware configurations of the center server 1 and the user terminal 2. The center server 1 includes, in its hardware configuration, a CPU 101, a memory 102, an external storage device 103, and a communication unit 104. The memory 102 and the external storage device 103 are computer-readable recording media. The center server 1 is one example of the “information processing device.”

The external storage device 103 stores various programs and data that the CPU 101 uses to execute the programs. The external storage device 103 is, for example, an erasable programmable ROM (EPROM) or a hard disk drive. Examples of the programs held by the external storage device 103 include an operating system (OS), a control program of the event planning system 100, and various other application programs.

The memory 102 is a storage device that provides the CPU 101 with a storage area and a work area for loading a program stored in the external storage device 103, and that is used as a buffer. Examples of the memory 102 include semiconductor memories, such as a read-only memory (ROM) and a random-access memory (RAM).

The CPU 101 executes various processes by loading the OS or the various application programs stored in the external storage device 103 onto the memory 102 and executing them. The number of the CPUs 101 is not limited to one and a plurality of CPUs may be provided. The CPU 101 is one example of the “control unit.”

The communication unit 104 is, for example, a network card for a local area network (LAN) or communication by wire, such as a dedicated line, and connects to the network N1 through an access network such as the LAN. The hardware configuration of the center server 1 is not limited to the one shown in FIG. 2.

The user terminal 2 includes, in its hardware configuration, a CPU 201, a memory 202, an external storage device 203, a wireless communication unit 204, and a touch panel display 205. FIG. 2 shows only those hardware devices that are extracted as relevant to the event planning system 100, and the hardware configuration of the user terminal 2 is not limited to the one shown in FIG. 2.

The CPU 201, the memory 202, and the external storage device 203 are similar to the CPU 101, the memory 102, and the external storage device 103, respectively, and therefore description thereof will be omitted. The external storage device 203 stores a client application program of the event planning system 100.

The wireless communication unit 204 is a wireless communication circuit compatible with a mobile communication system, such as 5th Generation (5G), Long-Term Evolution (LTE), LTE-Advanced, or 3G, or with a wireless communication system, such as WiFi. The wireless communication unit 204 connects to the access network by wireless communication and connects to the network N1 through the access network.

The touch panel display 205 is one example of an input device and an output device. For example, a user operation is input into the touch panel display 205 and the contents of the user operation are output to the CPU 201. Further, the touch panel display 205 displays image data by a command from the CPU 201.

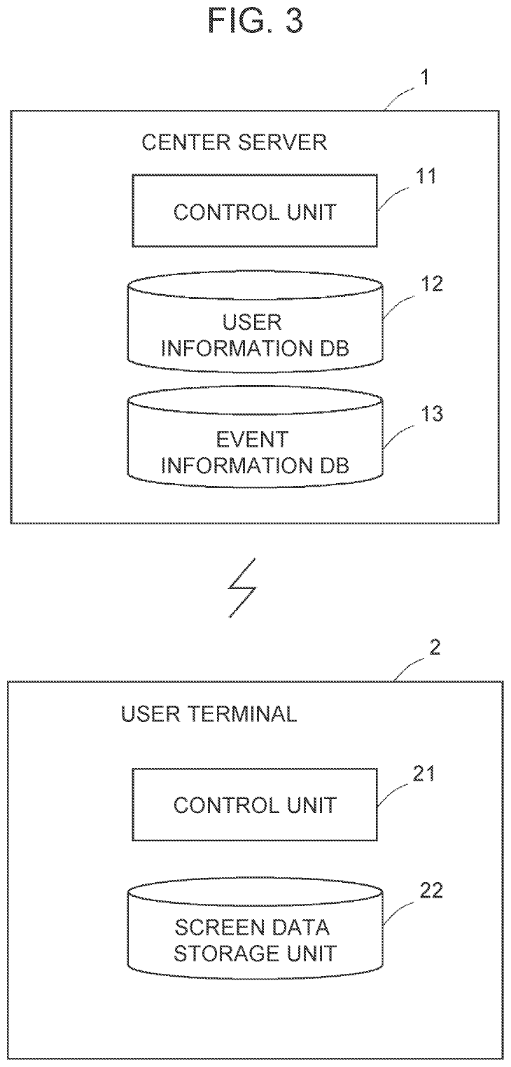

FIG. 3 is a view showing one example of the functional configurations of the center server 1 and the user terminal 2. The user terminal 2 includes, in its functional configuration, a control unit 21 and a screen data storage unit 22. These functional components are realized, for example, as the CPU 201 of the user terminal 2 executes the client application program of the event planning system 100.

The control unit 21 receives an input of a user operation, such as requesting registration of user information, requesting recording of a favorite resource, requesting disclosure of an event, responding to an event-running offer, and requesting to participate in an event, via the touch panel display 205. Through the wireless communication unit 204, the control unit 21 sends, for example, a user information registration request, favorite resource recording request, event disclosure request, response to an event-running offer, and event participation request to the center server 1. The control unit 21 calls up a screen corresponding to the user operation and the data etc. received from the center server 1 from the screen data storage unit 22 and outputs the screen on the touch panel display 205.

The screen data storage unit 22 is formed in a storage area of the external storage device 203. The screen data storage unit 22 holds screen data in the client application program of the event planning system 100. Details of a process of the control unit 21 and details of the screen data held by the screen data storage unit 22 will be described later.

Next, the center server 1 includes, in its functional configuration, a control unit 11, a user information DB 12, and an event information DB 13. These functional components are realized, for example, as the CPU 101 of the center server 1 executes the control program of the event planning system 100 stored in the external storage device 103.

The control unit 11 performs management of user information and event information. Through the communication unit 104, the control unit 11 receives a user information registration request, a favorite resource recording request, etc. from the user terminal 2. In response to the user information registration request, the favorite resource recording request, etc. received from the user terminal 2, the control unit 11 updates the corresponding user information in the user information DB 12 to be described later.

Further, through the communication unit 104, the control unit 11 receives, for example, an event disclosure request, an event participation request, etc. from the user terminal 2. User identification information on the user of the user terminal 2 that has sent the event disclosure request and the event participation request is also received along with these requests. Event information and user identification information on candidate event-running users are also received along with the event disclosure request.

When an event disclosure request is received, the control unit 11 discloses the event on the website of the event planning system 100. By disclosing the event, the control unit 11 starts to recruit event-running users and supporters for the event, and starts to receive requests to participate as an event-running user or a supporter for the event.

The control unit 11 discloses the event and, at the same time, sends an event-running offer to the user terminals 2 of the candidate event-running users designated by the originator user. When responses accepting the event-running offer are received from all the candidate event-running users designated by the originator user, the control unit 11 determines that the event is validated. When a response declining the event-running offer is received from one of the candidate event-running users designated by the originator user, the control unit 11 determines that the event is invalidated. When an event is invalidated, the planning thereof itself ends.

When an event participation request is received, the control unit 11 adds information on the user who has sent the participation request to the corresponding event information in the event information DB 13, to be described later, as an event-running user or a supporter. For example, when the number of supporters for the event has reached a predetermined number at a point when a predetermined period has elapsed since validation of the event, the control unit 11 determines that the event is to take place. When the number of supporters for the event falls short of the predetermined number at a point when the predetermined period has elapsed since validation of the event, the control unit 11 determines that the event is canceled. Details of the process of the control unit 11 will be described later.

The user information DB 12 and the event information DB 13 are created in the storage area of the external storage device 103. The user information DB 12 holds user information about users. The event information DB 13 holds event information about events. Details of the information held in the user information DB 12 and the event information DB 13 will be described later. The functional configurations of the center server 1 and the user terminal 2 are not limited to the example shown in FIG. 3.

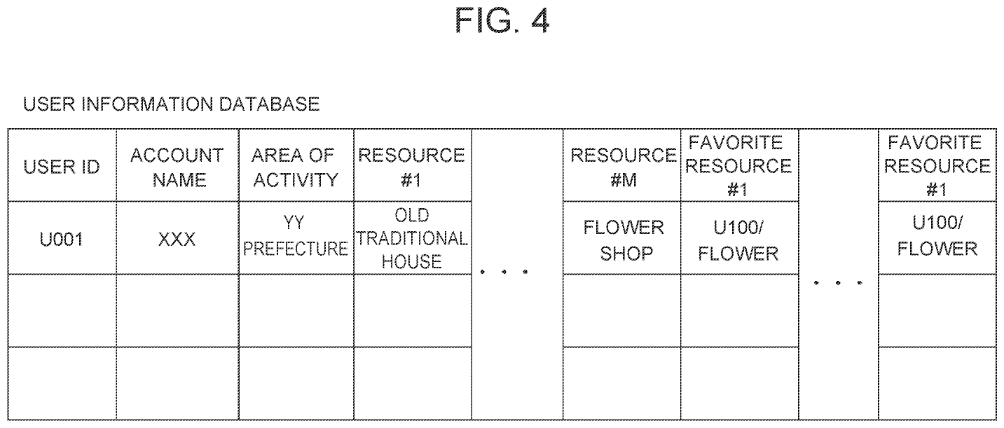

FIG. 4 is a view showing one example of the information held in the user information DB 12. The user information DB 12 holds user information about users. One record of the user information DB 12 corresponds to user information on one user. One record of the user information DB 12 includes, for example, the following fields: user ID, account name, area of activity, resource #1, . . . resource #M, favorite resource #1, . . . favorite resource #N. Symbols M and N both represent positive integers.

In the “user ID” field, user identification information is stored. For example, user identification information is uniquely assigned by the control unit 11 in the event planning system 100 at the time of user registration. In the “account name” field, an account name of the user is stored. In the “area of activity” field, information showing an area of activity of the user is stored. For example, information showing the area of activity of the user may be a code. In the “resource #1”, . . . “resource #M” fields, resource information on the user is stored.

In the “favorite resource #1”, . . . “favorite resource #N” fields, resource information on other users that the user has memorized is stored. More specifically, in the “favorite resource #1,” . . . “favorite resource #N” fields, a combination of user identification information on another user and one piece of the resource information on that user is stored.

Values in the “account name,” “area of activity,” “resource #1,” . . . “resource #M,” and “favorite resource #1,” . . . “favorite resource #N” fields are specified by the user. The information held in the user information DB 12 shown in FIG. 4 is one example, and the information held in the user information DB 12 is not limited to the example shown in FIG. 4.

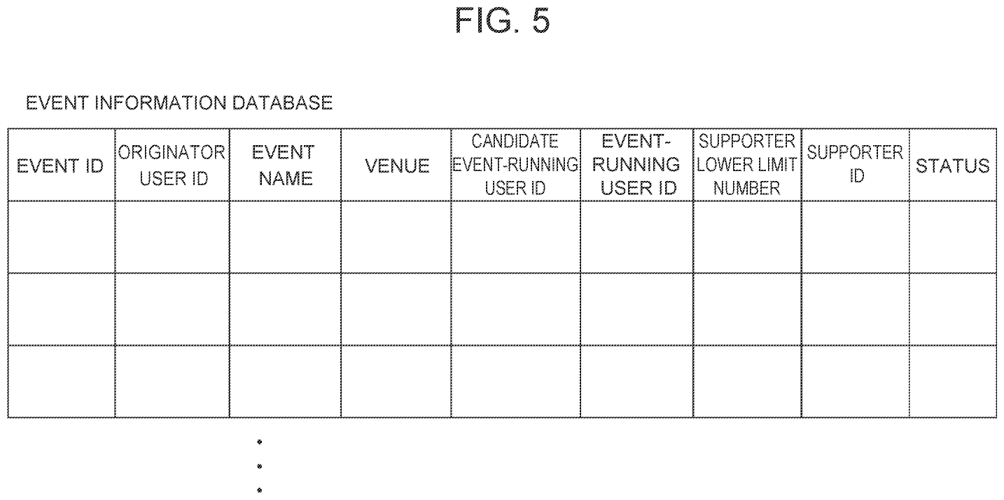

FIG. 5 is one example of the information held in the event information DB 13. The event information DB 13 stores event information about events. One record of the event information DB 13 corresponds to event information on one event. One record of the event information DB 13 includes, for example, the following fields: event ID, originator user ID, event name, venue, candidate event-running user ID, event-running user ID, supporter lower limit number, supporter ID, and status.

In the “event ID” field, event identification information is stored. For example, event identification information is uniquely assigned by the control unit 11 in the event planning system 100. In the “originator user ID” field, user identification information on the originator user is stored. In the “event name” field, the event name is stored. In the “venue” field, information showing an area where the event is to be held is stored. In the “candidate event-running user ID” field, user identification information on a candidate event-running user is stored. In the “event-running user ID” field, identification information on an event-running user is stored. In the “supporter lower limit number” field, a minimum required number of supporters is stored. In the “supporter ID” field, user identification information on a supporter is stored.

In the “status” field, information showing the status of the event is stored. Examples of information showing the status of an event include a flag and a code. Details of the status of an event will be described later. The information held in the event information DB 13 shown in FIG. 5 is one example, and the information held in the event information DB 13 is not limited to the example shown in FIG. 5.

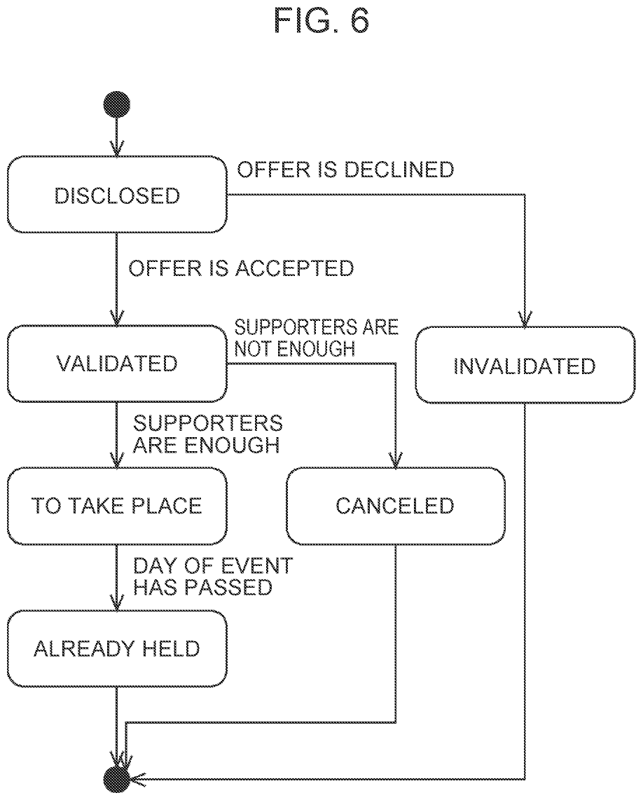

FIG. 6 is a view showing one example of transition of the status of an event. Examples of the event status includes disclosed, validated, invalidated, to take place, canceled, and already held. The initial status is “disclosed.” When responses accepting an event-running offer are received from all candidate event-running users, the event status shifts from “disclosed” to “validated.” When the event status becomes “validated,” the control unit 11 permits interaction between the originator user and the event-running users. The control unit 11 permits interaction between the originator user and the event-running users by, for example, creating a web page where the originator user and the event-running users can exchange messages and allowing the originator user and the event-running users to access this web page.

When a response declining the event-running offer is obtained from at least one of the candidate event-running users, the event status shifts from “disclosed” to “invalidated.” An event of which the status has become “invalidated” stops being disclosed after a lapse of a predetermined period.

When the number of supporters reaches a minimum required number, the event status shifts from “validated” to “to take place.” When the number of supporters does not reach the minimum required number after a lapse of the predetermined period, the event status shifts from “validated” to “canceled.” An event of which the status has become “canceled” stops being disclosed after a lapse of a predetermined time. For an event of which the status has become “canceled,” the control unit 11 stops the originator user and the event-running users from interacting with each other. The control unit 11 stops the originator user and the event-running users from interacting with each other by, for example, prohibiting creation of new messages on the web page where the originator user and the event-running users can exchange messages.

The minimum required number of supporters is specified by, for example, the originator user. The time to determine cancelation of an event may be uniformly set in advance or may be specified by the originator user.

When the day of the event has passed, the event status shifts from “to take place” to “already held.” An event of which the status has become “already held” stops being disclosed after a lapse of a predetermined period. For an event of which the status has become “already held,” the control unit 11 stops the originator user and the event-running users from interacting with each other.

The control unit 11 determines transition of the event status, and when the event status transitions, updates the “status” field of the corresponding record in the event information DB 13. The event status is not limited to those shown in FIG. 6 but can be changed as appropriate according to the embodiment.

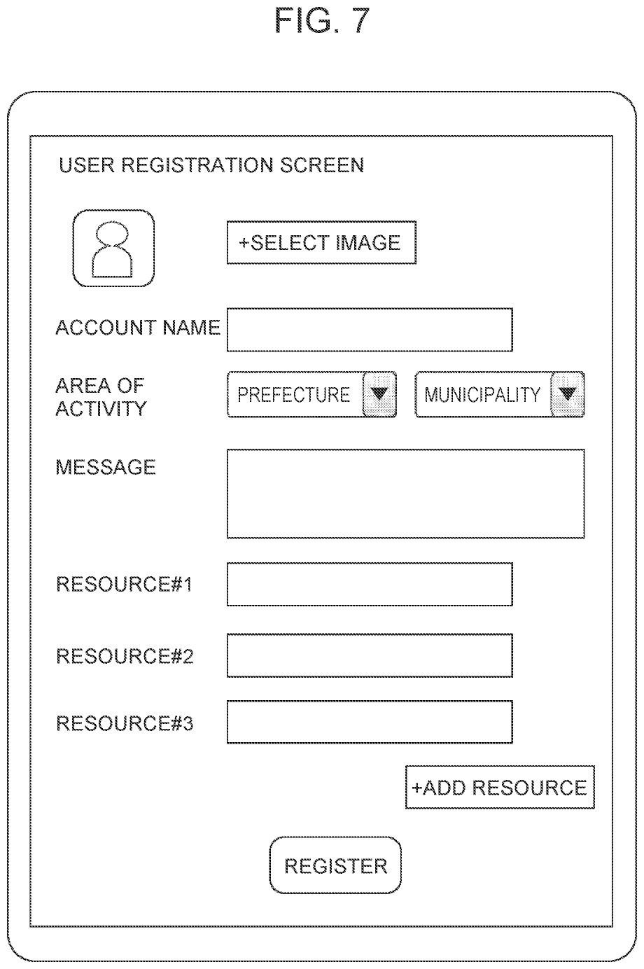

FIG. 7 to FIG. 13 are examples of the screen of the user terminal 2. FIG. 7 is one example of a user registration screen of the user terminal 2. The user registration screen is a screen in which information is registered when registering in the event planning system 100. The user registration screen has, for example, sections for inputting an account name, a user image, an area of activity, a self-introduction message, and resource information. Texts can be freely input in the sections for inputting an account name, a message, and resource information. An area of activity is input by, for example, selecting from a drop-down menu list.

When a “register” button at the bottom of the screen is selected, a user operation of requesting registration of user information is input into the user terminal 2. When the user operation of requesting registration of user information is input, the control unit 21 sends the user information input in the user registration screen and a user information registration request to the center server 1. Upon receiving the user information registration request from the user terminal 2, the control unit 11 of the center server 1 assigns user identification information to the user and newly registers the user information in the user information DB 12 (see FIG. 4). The user registration screen shown in FIG. 7 is one example, and the configuration of the user registration screen is not limited to the example shown in FIG. 7.

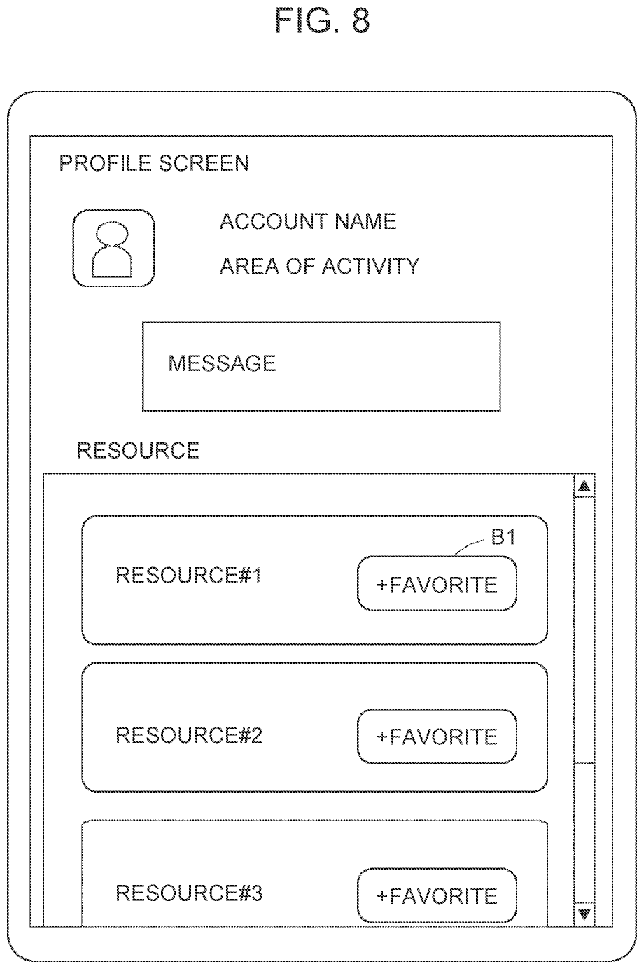

FIG. 8 is one example of a profile screen of the user terminal 2. The profile screen is a screen in which user information is displayed. In the profile screen, pieces of user information including an account name, an area of activity, a self-introduction message, and resource information are displayed.

Each section displaying resource information is provided with an “add to favorites” button Bl. When the “add to favorites” button is selected, the corresponding resource information on the user displayed in the profile screen can be registered in a favorites folder of the user who is displaying the profile screen. When the “add to favorites” button is selected, a user operation of requesting recording of resource information is input into the user terminal 2. When a resource information recording request is input, the control unit 21 of the user terminal 2 sends the resource information recording request, the user identification information, and the identification information and the resource information on the target user to the center server 1.

Upon receiving the resource information recording request from the user terminal 2, the control unit 11 of the center server 1 adds a “favorite resource” field to the user information DB 12 corresponding to the user of the user terminal 2 that has sent the request, and registers the identification information and the resource information on the user that have been received along with the recording request (see FIG. 4). The profile screen shown in FIG. 8 is one example, and the configuration of the profile screen is not limited to the example shown in FIG. 8.

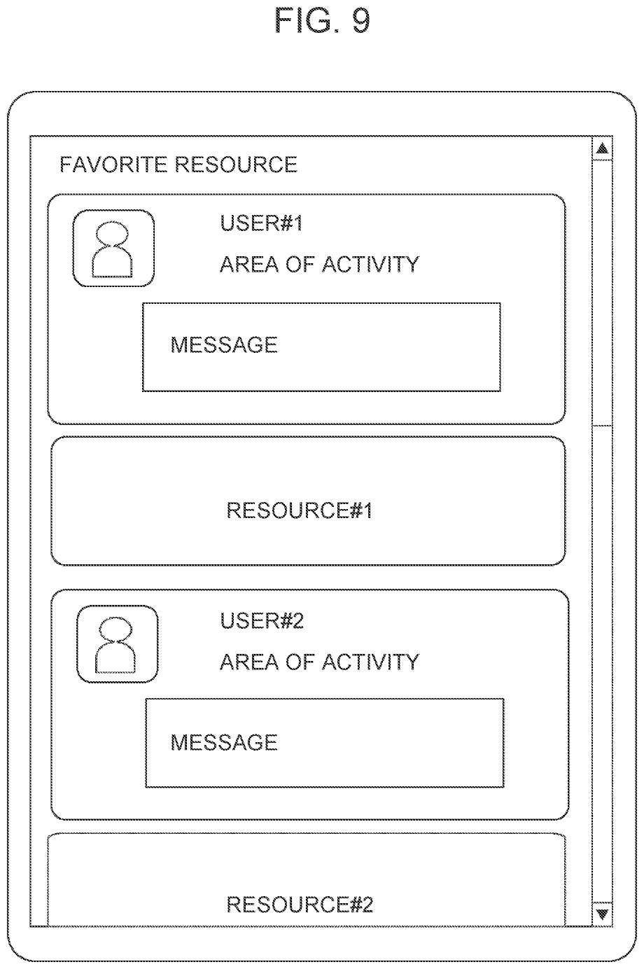

FIG. 9 is one example of a favorite resource list display screen of the user terminal 2. The favorite resource list display screen is a screen that displays a list of pieces of resource information on other users that have been registered as favorites. The favorite resource list screen is displayed by, for example, manipulating a menu.

In the favorite resource screen, for example, for each piece of resource information registered as a favorite, the user's profile image, account name, area of activity, self-introduction message, and resource information are displayed.

In the favorite resource list display screen, when, for example, a user operation of commanding the favorite resource list display screen to be displayed is input into the user terminal 2, the control unit 21 of the user terminal 2 sends a favorite resource acquisition request to the center server 1. Upon receiving the favorite resource acquisition request from the user terminal 2, the control unit 11 of the center server 1 acquires a combination of the user identification information and the resource information in the “favorite resource” field from the record of the corresponding user in the user information DB 12 and sends this combination to the user terminal 2 (see FIG. 4). Here, as the user information on each user, the user's profile image, account name, area of activity, and self-introduction message are also sent to the user terminal 2. The favorite resource list display screen shown in FIG. 9 is one example, and the configuration of the favorite resource list display screen is not limited to the example shown in FIG. 9.

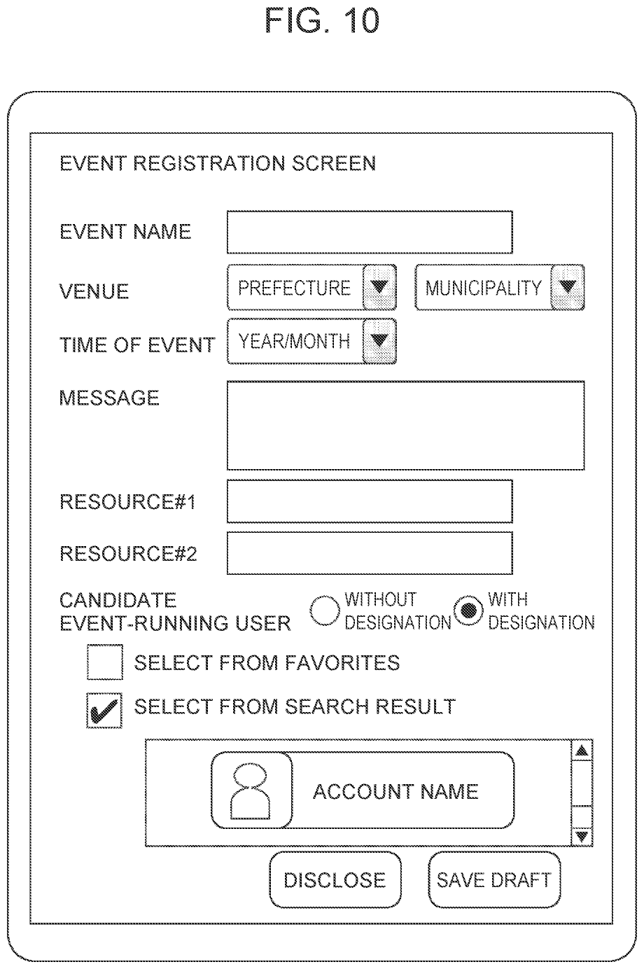

FIG. 10 is one example of an event registration screen of the user terminal 2. The event registration screen is a screen in which information is input when an event is originally proposed. The event registration screen is displayed by, for example, manipulating the menu.

The event registration screen is provided with, for example, sections for inputting an event name, venue, time of event, message summarizing the event, resource information relating to the event, and designation of candidate event-running users. Texts can be freely input in the sections for inputting an event name, message summarizing the event, and resource information relating to the event. The venue and the time of the event are input by, for example, selecting from a pull-down menu. The sections for inputting the venue and the time of the event may be left blank.

The section for inputting designation of candidate event-running users includes radio buttons for selecting whether to designate them. For example, when a “with designation” radio button is selected, check boxes for selecting a method of selecting candidate event-running users are displayed. Methods of selecting candidate event-running users include, for example, a method of selecting from favorite resources and a method of selecting from a result of a search by resource information. The check box of “select from favorites” is a check box for selecting the method of selecting candidate event-running users from favorite resources. The check box of “select from search result” is a check box for selecting the method of selecting candidate event-running users from a result of a search by resource information.

For example, when the check box of “select from favorites” is checked, the current screen transitions to the favorite resource list display screen (FIG. 9), where candidate event-running users can be designated from the resource information of other users registered in the favorite resource.

For example, when the check box of “select from search result” is checked, the current screen transitions to a user search screen to be described later, where a search for users is made by resource information and candidate event-running users can be designated from among users in the search result.

In the event registration screen shown in FIG. 10, information on a candidate event-running user selected by the user is displayed under the check boxes for selecting the method of selecting candidate event-running users.

Further, in the event registration screen shown in FIG. 10, a “disclose” button is provided at the bottom of the screen. When the “disclose” button is selected, a user operation of requesting disclosure of the event is input into the user terminal 2, and the control unit 21 of the user terminal 2 sends a disclosure request, the user identification information, and the event information to the center server 1. The event information sent to the center server 1 in this case includes, for example, the event name, the venue, the time of the event, the summary message, the resource information relating to the event, and the user identification information on the candidate event-running users. Information on the venue, the time of the event, and the user identification information on the candidate event-running users is sent if these have been input.

Upon receiving the event disclosure request from the user terminal 2, the control unit 11 of the center server 1 assigns event identification information to the event and registers the event information in the event information DB 13 (see FIG. 5), discloses this event information, and sends an event-running offer to the candidate event-running users. The event registration screen shown in FIG. 10 is one example, and the configuration of the event registration screen can be changed as appropriate according to the embodiment.

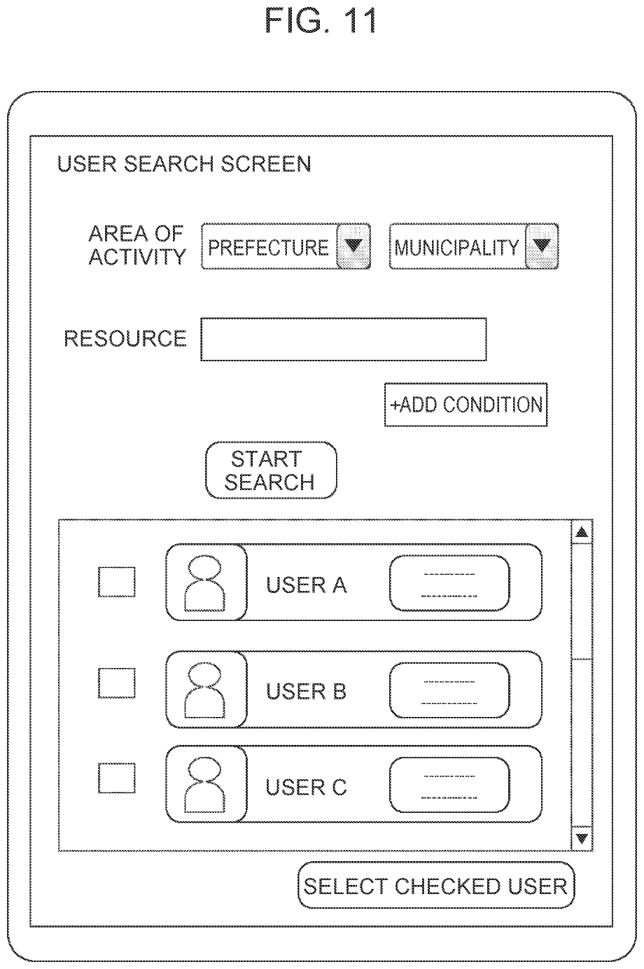

FIG. 11 is one example of the user search screen of the user terminal 2. The user search screen is a screen in which users are searched for by resource information. For example, the user search screen is displayed by manipulating the menu, or is displayed when the method of selecting from a result of a search by resource information is selected as the method of selecting candidate event-running users in the event registration screen (FIG. 10).

The user search screen is provided with, for example, sections for inputting an area of activity and resource information as search conditions. The area of activity is input by, for example, selecting from a pull-down menu. The section for inputting the area of activity may be left blank. Texts can be freely input in the section for inputting the resource information.

The user search screen is provided with a “search start” button, and when the “search start” button is selected, a user operation of requesting a search for users is input into the user terminal 2. When the user operation of requesting a search for users is input, the control unit 21 of the user terminal 2 sends a user search request and the input search conditions to the center server 1. Upon receiving the user search request from the user terminal 2, the control unit 11 of the center server 1 searches the user information DB 12 for user information by the received search conditions and sends the search result to the user terminal 2. The search result includes user identification information, an account name, a profile image, a self-introduction message, and resource information. Upon receiving the search result from the center server 1, the control unit 21 of the user terminal 2 displays the search result on the user search screen.

A user search result is displayed on the lower side of the user search screen shown in FIG. 11. Each user displayed is accompanied by a check box, and checking this check box and selecting a “select checked user” button can select the checked user. The user search screen shown in FIG. 11 is one example, and the configuration of the user search screen can be changed as appropriate according to the embodiment.

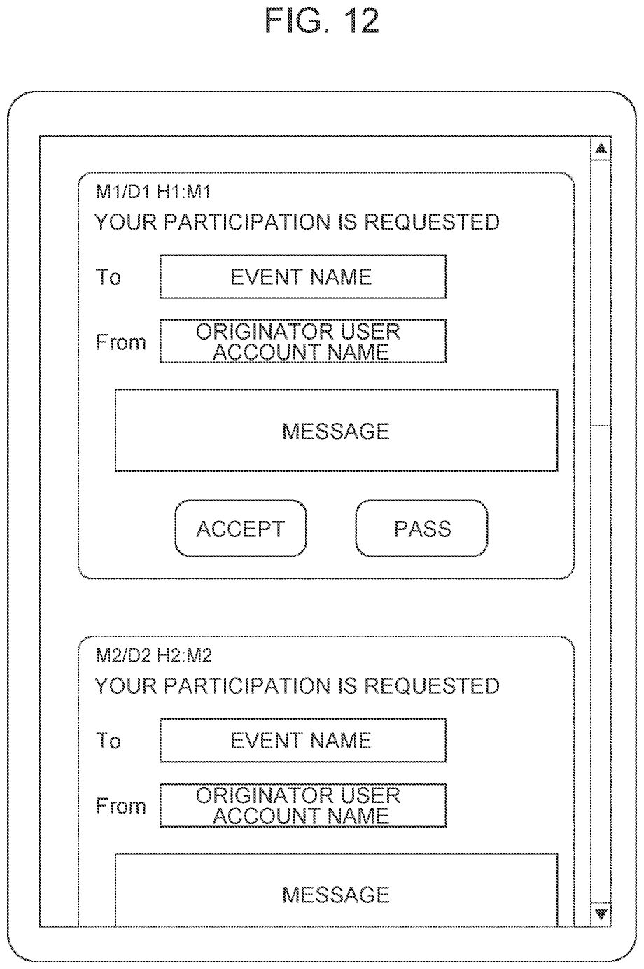

FIG. 12 is one example of an event-running offer list screen of the user terminal 2. The event-running offer list screen is a screen that displays a list of events for which the user is designated as a candidate event-running user. The event-running offer list screen is displayed by, for example, manipulating the menu.

The event-running offer list screen includes sections displaying pieces of information on the respective events for which an event-running offer has been received. Each section displaying event information that is displayed in the event-running offer list screen includes the time and date of reception of the event-running offer, the event name, the account name of the originator user, and the descriptive message summarizing the event. Further, each section displaying information on an event shown in FIG. 12 includes an “accept” button and a “pass” button.

When the “accept” button is selected, a user operation of responding to accept the event-running offer for the event is input into the user terminal 2. When the “pass” button is selected, a user operation of responding to decline the event-running offer for the event is input into the user terminal 2.

When a user operation of responding to accept the event-running offer is input, the control unit 21 of the user terminal 2 sends a response accepting the corresponding event-running offer to the center server 1. When a user operation of responding to decline the event-running offer is input, the control unit 21 of the user terminal 2 sends a response declining the corresponding event-running offer to the center server 1. Each of a response of acceptance and a response of declination is sent along with the user identification information and the event identification information on the corresponding event.

Upon receiving a response accepting the event-running offer from the user terminal 2, the control unit 11 of the center server 1 updates the record of the corresponding event in the event information DB 13 (FIG. 5). Specifically, the control unit 11 deletes the corresponding user identification information from the “candidate event-running user ID” field of the record of the corresponding event in the event information DB 13 and adds this user identification information to the “event-running user ID” field. Upon receiving a response declining the event-running offer, for example, the control unit 11 does not update the event information DB 13.

When the “candidate event-running user ID” field of the record of the corresponding event in the event information DB 13 is blank after a lapse of a predetermined period, this shows that all the candidate event-running users have responded to accept the event-running offer. In this case, the control unit 11 of the center server 1 determines that the event is validated and updates the “status” field of the record of the corresponding event in the event information DB 13 from “disclosed” to “validated.”

On the other hand, when any user identification information is stored in the “candidate event-running user ID” field of the record of the corresponding event in the event information DB 13 after a lapse of the predetermined period, or when one of the candidate event-running users has responded to decline the event-running offer, the control unit 11 of the center server 1 determines that the event is invalidated. The control unit 11 updates the “status” field of the record of the corresponding event in the event information DB 13 from “disclosed” to “invalidated.” The event-running offer list screen shown in FIG. 12 is one example, and the configuration of the event-running offer list screen can be changed as appropriate according to the embodiment.

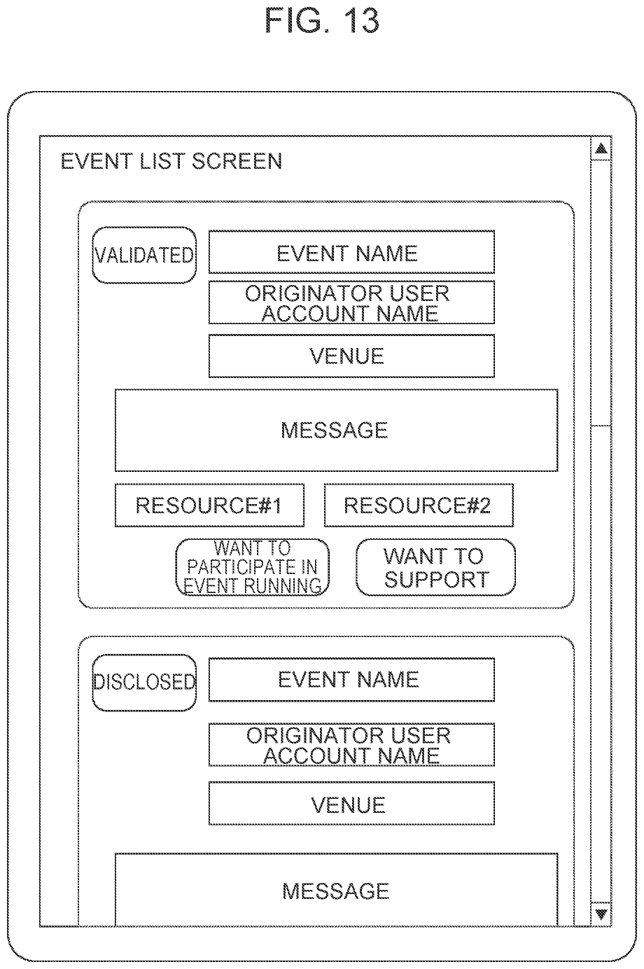

FIG. 13 is one example of an event list screen of the user terminal 2. The event list screen is a screen that displays a list of events being proposed. The event list screen is displayed by, for example, manipulating the menu. Events displayed in the event list screen are events of which the status is one of “disclosed,” “validated,” and “to take place.” Events of which the status is “invalidated” or “canceled” are displayed in the event list screen for a predetermined period after that status is reached, and are excluded from events displayed in the event list screen after a lapse of the predetermined period. That an event is disclosed means, for example, that the event is displayed in the event list screen.

The event list screen includes sections each displaying an event. Each section displaying an event includes, for example, an event status, event name, account name of the originator user, venue, message describing a summary, and resource information relating to the event. Further, each section displaying an event includes a “want to participate in event running” button and a “want to support” button.

When the “want to participate in event running” button is selected, a user operation of requesting to participate as an event-running user for the corresponding event is input into the user terminal 2. When the “want to support” button is selected, a user operation of requesting to participate as a supporter for the corresponding event is input into the user terminal 2. When a user operation of requesting to participate as an event-running user or requesting to participate as a supporter is input, the control unit 21 of the user terminal 2 sends an event participation request to the center server 1. For example, the user identification information, the corresponding event identification information, and information showing whether the user wishes to participate as an event-running user or a supporter are sent along with the event participation request. This information showing whether the user wishes to participate as an event-running user or a supporter may be, for example, a flag or a code.

Upon receiving the event participation request from the user terminal 2, the control unit 11 of the center server 1 updates the record of the corresponding event in the event information DB 13 (FIG. 5). For example, when the event participation request shows that the user wishes to participate as an event-running user, the control unit 11 adds the user identification information that has been received along with the participation request to the event-running user ID of the record of the corresponding event in the event information DB 13. For example, when the event participation request shows that the user wishes to participate as a supporter, the control unit 11 adds the user identification information that has been received along with the participation request to the supporter ID of the record of the corresponding event in the event information DB 13. In both of the case where the user wishes to participate as an event-running user and the case where the user wishes to participate as a supporter, the control unit 11 may update the event information DB 13 after confirming with the originator user as to whether the participation as wished is possible.

Flow of Process

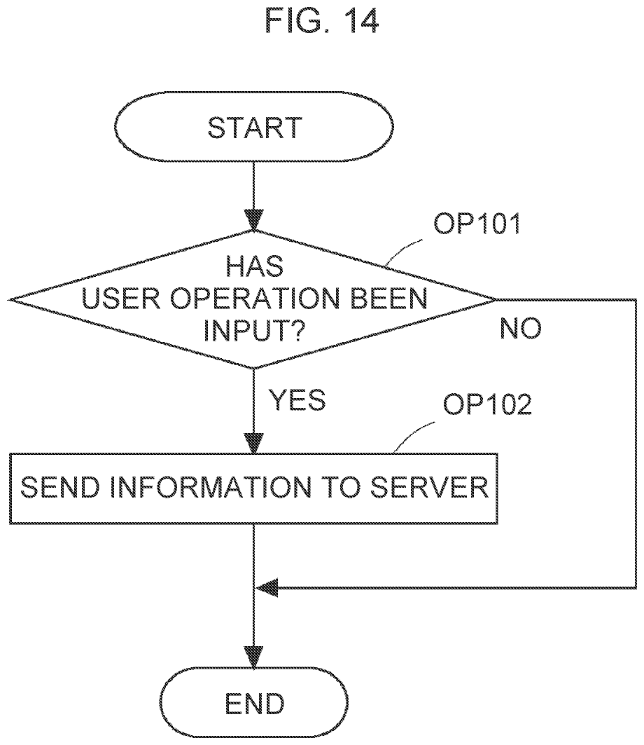

FIG. 14 is one example of a flowchart of the process of the user terminal 2. The process shown in FIG. 14 is, for example, repeatedly executed in the user terminal 2 during execution of the client application program of the event planning system 100. While the subject that executes the process shown in FIG. 14 is the CPU 201 of the user terminal 2, for convenience, the process will be described with a functional component as the subject.

In OP101, the control unit 21 determines whether a user operation has been input. In the first embodiment, examples of user operations input into the user terminal 2 include requesting registration of user information, requesting recording of resource information, requesting a search for users, requesting for acquisition of a favorite resource, requesting disclosure of an event, requesting to participate in an event, and responding to an event-running offer.

When a user operation has been input (OP101: YES), the process moves to OP102. When no user operation has been input (OP101: NO), the process shown in FIG. 14 ends.

In OP102, the control unit 21 sends information corresponding to the user operation input in OP101 to the center server 1. For example, when a user operation of requesting registration of user information has been input, the control unit 21 sends a user information registration request and the user information to the center server 1.

For example, when a user operation of requesting recording of resource information has been input, the control unit 21 sends a resource information recording request, the user identification information, and a combination of user identification information and resource information to be recorded to the center server 1. For example, when a user operation of requesting a search for users has been input, the control unit 21 sends a user search request and search conditions to the center server 1. For example, when a user operation of requesting acquisition of a favorite resource has been input, the control unit 21 sends a favorite resource acquisition request and the user identification information to the center server 1.

For example, when a user operation of requesting disclosure of an event has been input, the control unit 21 sends an event disclosure request, the user identification information, and the event information to the center server 1. For example, when a user operation of requesting to participate in an event has been input, the control unit 21 sends an event participation request, the user identification information, event identification information on the target event, and information showing whether the user wishes to participate as an event-running user or a supporter to the center server 1. For example, when a user operation of responding to accept or decline an event-running offer has been input, the control unit 21 sends a response accepting or declining the event-running offer, the event identification information on the target event, and the user identification information to the center server 1. Then, the process shown in FIG. 14 ends. The process of the user terminal 2 is not limited to the process shown in FIG. 14, and the process can be changed as appropriate according to the embodiment.

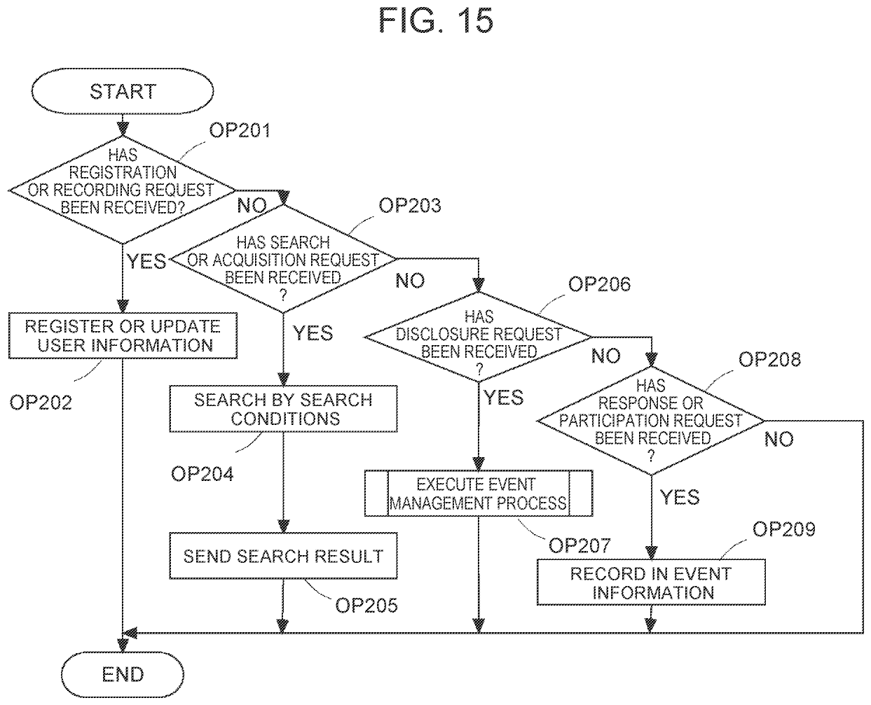

FIG. 15 is one example of a flowchart of the process of the center server 1. The process shown in FIG. 15 is repeatedly executed on a predetermined cycle. While the subject that executes the process shown in FIG. 15 is the event planning system 100 of the center server 1, for convenience, the process will be described with a functional component as the subject. The same applies to the subsequent flowcharts.

In OP201, the control unit 11 determines whether a user information registration request or a resource information recording request has been received from the user terminal 2. When a user information registration request or a resource information recording request has been received from the user terminal 2 (OP201: YES), the process moves to OP202. When neither of a user information registration request nor a resource information recording request has been received from the user terminal 2 (OP201: NO), the process moves to OP203.

In OP202, the control unit 11 updates the user information DB 12 according to the user information registration request or the resource information recording request received from the user terminal 2. For example, when a user information registration request has been received from the user terminal 2, the control unit 11 newly adds a record of the received user information to the event information DB 13 (FIG. 4). For example, when a resource information recording request has been received from the user terminal 2, the control unit 11 stores the received combination of the user identification information and the resource information in the “favorite resource” field of the corresponding record in the event information DB 13. Then, the process shown in FIG. 15 ends.

In OP203, the control unit 11 determines whether a user search request or a favorite resource acquisition request has been received from the user terminal 2. When a user search request or a favorite resource acquisition request has been received from the user terminal 2 (OP203: YES), the process moves to OP204. When neither of a user search request nor a favorite resource acquisition request has been received from the user terminal 2 (OP203: NO), the process moves to OP206.

In OP204, the control unit 11 searches the user information DB 12 by the search conditions according to the search request or the acquisition request. In OP205, the control unit 11 sends the search result of OP204 to the user terminal 2. Then, the process shown in FIG. 15 ends.

For example, when a user search request has been received, the control unit 11 searches the user information DB 12 by the search conditions that have been received along with the search request, and sends user information that meet the search conditions to the user terminal 2 as a search result. One example of search conditions in this case is resource information. For example, when a favorite resource acquisition request has been received, the control unit 11 sends to the user terminal 2, as a search result, a combination of the user identification information and the resource information stored in the “favorite” field of the record in the event information DB 13 that corresponds to the user identification information having been received along with the acquisition request. Further, the control unit 11 sends user information corresponding to each piece of user identification information that have been detected as a search result to the user terminal 2.

In OP206, the control unit 11 determines whether an event disclosure request has been received from the user terminal 2. When an event disclosure request has been received from the user terminal 2 (OP206: YES), the process moves to OP207. When an event disclosure request has not been received from the user terminal 2 (OP206: NO), the process moves to OP208.

In OP207, the control unit 11 executes an event management process. The event management process is a process of managing the event status. Details of the event management process will be described later. Then, the process shown in FIG. 15 ends.

In OP208, the control unit 11 determines whether a response to the event-running offer or an event participation request has been received from the user terminal 2. When a response to the event-running offer or an event participation request has been received from the user terminal 2 (OP208: YES), the process moves to OP209. When neither of a response to the event-running offer nor an event participation request has been received from the user terminal 2 (OP208: NO), the process shown in FIG. 15 ends.

In OP209, the control unit 11 updates the event information DB 13 according to the response to the event-running offer or the event participation request received from the user terminal 2. For example, when a response accepting the event-running offer is received from the user terminal 2, the control unit 11 deletes the user identification information having been received along with the participation request from the “candidate event-running user” field of the record in the event information DB 13 corresponding to the event identification information having been received along with the participation request, and adds this user identification information to the “event-running user” field (FIG. 5). For example, when an event participation request has been received from the user terminal 2, the control unit 11 adds the user identification information having been received along with the participation request to the “event-running user” or “supporter” field of the record in the event information DB 13 corresponding to the event identification information having been received along with the participation request (FIG. 5). Then, the process shown in FIG. 15 ends.

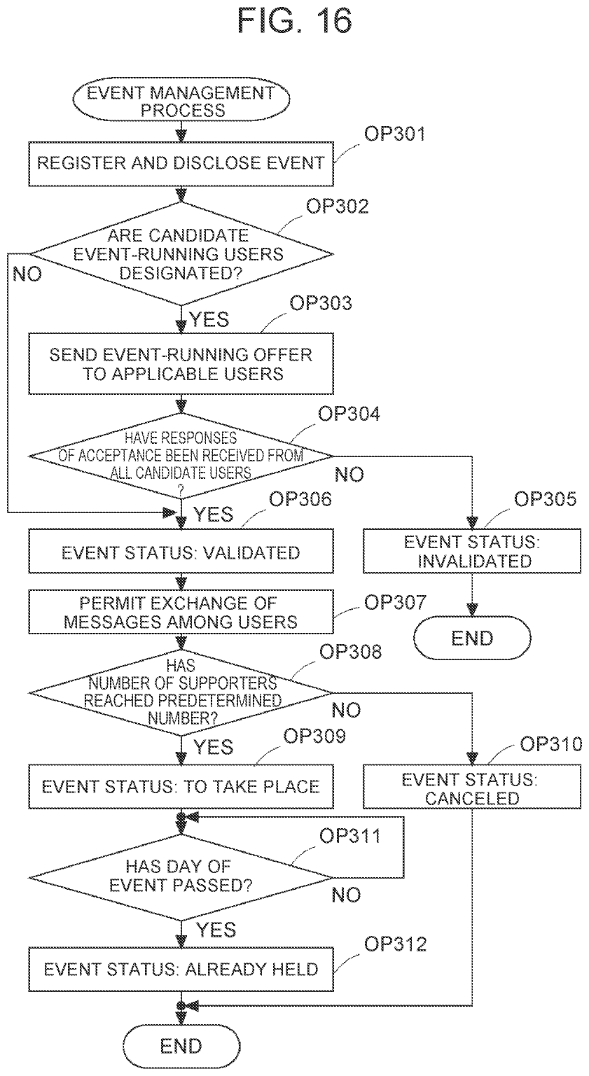

FIG. 16 is one example of a flowchart of the event management process of the center server 1. The process shown in FIG. 16 corresponds to the process of OP207 of FIG. 15. The process shown in FIG. 16 is started when an event disclosure request is received from the user terminal 2.

In OP301, the control unit 11 registers event information that has been received along with an event disclosure request to the event information DB 13 and discloses the information. In OP302, the control unit 11 determines whether candidate event-running users are designated. When candidate event-running users are designated, user identification information on the candidate event-running users is received from the user terminal 2 along with the event disclosure request. When candidate event-running users are not designated (OP302: NO), the process moves to OP306.

In OP303, the control unit 11 sends an event-running offer to the user terminals 2 of the candidate event-running users. The event identification information is sent along with the event-running offer.

In OP304, the control unit 11 determines whether responses of acceptance have been received from all the candidate event-running users designated by the originator user. When responses of acceptance have been received from all the candidate event-running users designated by the originator user (OP304: YES), the process moves to OP306. When a response of declination has been received from one of the candidate event-running users designated by the originator user, or when responses of acceptance have not been received from all the candidate event-running users after a lapse of a predetermined period (OP304: NO), the process moves to OP305.

In OP305, the control unit 11 determines that the event status has transitioned from “disclosed” to “invalidated,” and updates the “status” field of the corresponding record in the event information DB 13. Then, the process shown in FIG. 16 ends.

In OP306, the control unit 11 determines that the event status has transitioned from “disclosed” to “validated,” and updates the “status” field of the corresponding record in the event information DB 13. In OP307, the control unit 11 permits exchange of messages between the originator user and the event-running users.

In OP308, the control unit 11 determines whether the number of supporters for the event has reached a predetermined number. When the number of supporters for the event has reached the predetermined number (OP308: YES), the process moves to OP309. When the number of supporters for the event does not reach the predetermined number after a lapse of the predetermined period (OP308: NO), the process moves to OP310. When candidate event-running users are not designated in OP302, the control unit 11 may further determine whether the number of event-running users has reached a predetermined number in OP308. When both the number of event-running users and the number of supporters have reached predetermined numbers, the control unit 11 may determine in the affirmative in OP308. When either the number of event-running users or the number of supporters falls short of the predetermined number, the control unit 11 may determine in the negative in OP308.

In OP309, the control unit 11 determines that the event status has transitioned from “validated” to “to take place,” and updates the “status” field of the corresponding record in the event information DB 13. In OP310, the control unit 11 determines that the event status has transitioned from “validated” to “canceled,” and updates the “status” field of the corresponding record in the event information DB 13. Then, the process shown in FIG. 16 ends.

In OP311, the control unit 11 determines whether the day of the event has passed. When the day of the event has passed (OP311: YES), the process moves to OP312. When the day of the event has not passed (OP311: NO), the process of OP311 is repeated.

In OP312, the control unit 11 determines that the event status has transitioned from “to take place” to “already held,” and updates the “status” field of the corresponding record in the event information DB 13. Then, the process shown in FIG. 16 ends.

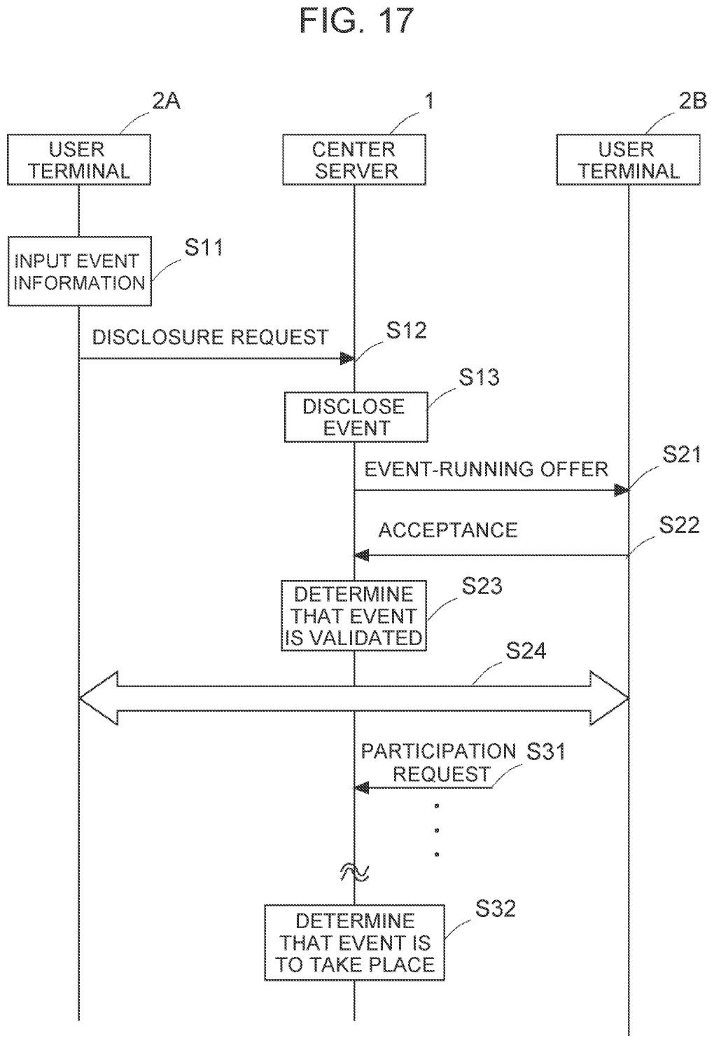

FIG. 17 is one example of a sequence chart of a process in the event planning system 100 from when an event is originally proposed until the event is determined to take place. In FIG. 17, the user terminal of the originator user is a user terminal 2A, and the user terminal of a candidate event-running user is a user terminal 2B.

In S11, the originator user inputs event information in the event registration screen (FIG. 10) of the user terminal 2A. The originator user designates the user of the user terminal 2B as a candidate event-running user. In S12, upon receiving an input of a user operation of requesting disclosure of the event from the originator user, the user terminal 2A sends an event disclosure request to the center server 1.

In S13, the center server 1 receives the event disclosure request from the user terminal 2A (OP206 of FIG. 15), and discloses the event information on the website of the event planning system 100 (OP301 of FIG. 16).

In S21, the center server 1 sends an event-running offer to the user terminal 2B of the candidate event-running user (OP303 of FIG. 16). In S22, the user terminal 2B receives an input of a user operation of responding to accept the event-running offer from the candidate event-running user and sends the response of acceptance to the center server 1. The center server 1 receives the response of acceptance from the user terminal 2B (OP304 of FIG. 16).

In the example shown in FIG. 17, it is assumed that no other candidate event-running users than the user of the user terminal 2B are designated. In S23, since the center server 1 has received a response of acceptance from all the candidate event-running users (OP304 of FIG. 16), the center server 1 determines that the event status has transitioned from “disclosed” to “validated” (OP306 of FIG. 16). In S24, the center server 1 permits exchange of messages between the user terminal 2A and the user terminal 2B (OP307 of FIG. 16). Thereafter, the originator user and the running user can interact with each other regarding the event by exchanging messages in the event planning system 100.

In S31, the center server 1 receives participation requests from the user terminals 2 of users who wish to participate in the event as event-running users or supporters. In S32, when a predetermined period has elapsed since disclosure of the event, or when the number of supporters has reached a predetermined number, the center server 1 determines that the event status has transitioned from “validated” to “to take place.” Thereafter, the event is held, and then the event status transitions from “to take place” to “already held” and disclosure of the event ends.

At the stage when the event status has become “to take place,” the place and date to hold the event and other details may be yet to be determined.

Workings and Effects of First Embodiment

In the first embodiment, when proposing an event, the user designates candidate event-running users, and then the center server 1 sends an event-running offer to those candidate event-running users. The originator user can designate candidate event-running users from among users with whom the originator user is not actually acquainted or has no connection in the event planning system 100 or other SNSs. Thus, the originator user can plan an event without recruiting candidate event-running users in advance, which can lower the hurdle of planning an event.

In the first embodiment, each user has his or her resource information disclosed, and the originator user designates candidate event-running users from among users resulting from a search by resource information. The event information includes resource information relating to the event, and the resource information is also disclosed when the event is disclosed. Thus, the event planning system 100 according to the first embodiment allows users to connect with each other through resource information. Resource information is arbitrarily specified by each user, and serves as a tool for expressing the worldview of the user or the event. Thus, users who have sympathized with the worldview of the event gather together, which creates unprecedented new opportunities for meeting people.

In the first embodiment, an originator user and candidate event-running users can interact with each other only after the event status shifts to “validated.” Further, the event status becomes “to take place” when the number of participants reaches a predetermined number. In the first embodiment, details of the event, such as the place and date to hold the event, may be yet to be determined when the event status is “to take place.” Usually, planning an event involves securing a place to hold the event and a budget in advance of planning. According to the first embodiment, however, there is no need to secure a place to hold an event and a budget before planning an event as in usual event planning. Users can act to secure a budget etc., for example, after the event is determined to take place, and therefore can plan an event with a light heart. Even when the event is invalidated or canceled, if a place to hold the event, a budget, etc. are not yet secured, money, effort, time, etc. involved in securing a place to hold the event, a budget, etc. can be prevented from going to waste.

In the first embodiment, for example, when a response to decline an event-running offer is received from a candidate event-running user and the event is “invalidated,” the originator user can plan the same event again by designating another user as a candidate event-running user. Thus, for example, even when an event is invalidated, the user can readily plan the same event again and therefore can plan an event with a light heart.

Candidate event-running users who have received an event-running offer have only to respond by selecting a button from the user terminal 2, and thus can easily accept or refuse the event-running offer. This can lower the hurdle for an event.

### OTHER EMBODIMENTS

The above-described embodiment is merely one example, and this disclosure can be implemented with changes made thereto as appropriate within a range that does not depart from the gist of the disclosure.

The event planning system 100 according to the first embodiment is intended for planning an event that is held with two or more persons actually gathering together. However, the technology described in the first embodiment is applicable to planning of not only events but also activities that are carried out with two or more activity-running users gathering together, such as crowd-funding.

The processes and means described in this disclosure can be implemented in arbitrary combinations to such an extent that no technical inconsistency arises.

Further, a process having been described as being performed by one device may be assigned to and executed by a plurality of devices. Or a process having been described as being performed by different devices may be executed by one device. What hardware configuration (server configuration) to use to realize the functions in the computer system can be flexibly changed.

This disclosure can also be realized by supplying a computer program featuring the functions described in the above embodiment to a computer and causing one or more processors belonging to the computer to read and execute the program. Such a computer program may be provided to a computer by a non-transitory computer-readable storage medium that can be connected to a system bus of the computer, or may be provided to a computer through a network. Examples of non-transitory computer-readable storage media include arbitrary types of disks such as a magnetic disk (a floppy® disk, a hard disk drive (HDD), etc.) and an optical disc (a CD-ROM, a DVD disc, a Blu-ray disc, etc.), and further include a read-only memory (ROM), random-access memory (RAM), EPROM, EEPROM, magnetic card, flash memory, optical card, and arbitrary types of media suitable for storing electronic commands.

What is claimed is:

1. An information processing method comprising:
receiving, from a user terminal of a first user, a disclosure request that is a request for disclosure of information about a plan of a predetermined activity to be hosted by the first user, and identification information on one or more second users who are designated by the first user from among a plurality of users as receivers of a request to participate in running the predetermined activity;
disclosing the information about the plan of the predetermined activity on a first website; and
sending a request to participate in running the predetermined activity to user terminals of the one or more second users.

2. The information processing method according to claim 1, wherein any user among the users is able to be designated as one of the one or more second users.

3. The information processing method according to claim 1, further comprising:
holding, in a storage unit, resource information about each of the users that includes a place, an object, and a thing relating to interests and concerns of the user and to skills that the user is able to offer, as a piece of user information about the user; and
disclosing the resource information about each of the users on the first website,
wherein the information about the plan of the predetermined activity includes at least one piece of the resource information connected with the first user.

4. The information processing method according to claim 3, wherein the one or more second users are users selected from a result of a search by a piece of the resource information specified by the first user.

5. The information processing method according to claim 3, further comprising:
receiving, from a user terminal of a third user among the users, a recording request that is a request for recording of first resource information disclosed about another user, and the first resource information; and
recording, in the storage unit, user information on the third user and the first resource information so as to be connected with each other.

6. The information processing method according to claim 1, further comprising:
determining that the plan of the predetermined activity is validated and making a disclosure to that effect, when, in response to the request to participate in running the predetermined activity, responses agreeing to participate in running the predetermined activity are received from all the user terminals of the one or more second users; and
determining that the plan of the predetermined activity is invalidated and making a disclosure to that effect, when, in response to the request to participate in running the predetermined activity, a response declining to participate in running the predetermined activity is received from at least one of the user terminals of the one or more second users.

7. The information processing method according to claim 6, further comprising permitting exchange of messages between the user terminal of the first user and the user terminals of the one or more second users after the plan of the predetermined activity is validated.

8. The information processing method according to claim 1, further comprising:
for the disclosed plan of the predetermined activity, receiving, from a user terminal of a fourth user, a participation request that shows that the fourth user desires to participate as a staff member; and
determining that the predetermined activity is to take place and making a disclosure to that effect, when the number of fourth users reaches a predetermined number for the disclosed plan of the predetermined activity, and determining that the predetermined activity is canceled and making a disclosure to that effect, when the number of fourth users falls short of the predetermined number.

9. An information processing device comprising a control unit that executes:
receiving, from a user terminal of a first user, a disclosure request that is a request for disclosure of information about a plan of a predetermined activity to be hosted by the first user, and identification information on one or more second users who are designated by the first user from among a plurality of users as receivers of a request to participate in running the predetermined activity;
disclosing the information about the plan of the predetermined activity on a first website; and
sending a request to participate in running the predetermined activity to user terminals of the one or more second users.

10. The information processing device according to claim 9, wherein any user among the users is able to be designated as one of the one or more second users.

11. The information processing device according to claim 9, further comprising a storage unit that holds resource information about each of the users that includes a place, an object, and a thing relating to interests and concerns of the user and to skills that the user is able to offer, as a piece of user information about the user,
wherein the control unit further executes disclosing the resource information about each of the users on the first website, and
wherein the information about the plan of the predetermined activity includes at least one piece of the resource information connected with the first user.

12. The information processing device according to claim 11, wherein the one or more second users are users selected from a result of a search by a piece of the resource information specified by the first user.

13. The information processing device according to claim 11, wherein the control unit further executes:
receiving, from a user terminal of a third user among the users, a recording request that is a request for recording of first resource information disclosed about another user, and the first resource information; and
recording, in the storage unit, user information on the third user and the first resource information so as to be connected with each other.

14. The information processing device according to claim 9, wherein the control unit further executes:
determining that the plan of the predetermined activity is validated and making a disclosure to that effect, when, in response to the request to participate in running the predetermined activity, responses agreeing to participate in running the predetermined activity are received from all the user terminals of the one or more second users; and
determining that the plan of the predetermined activity is invalidated and making a disclosure to that effect, when, in response to the request to participate in running the predetermined activity, a response declining to participate in running the predetermined activity is received from at least one of the user terminals of the one or more second users.

15. The information processing device according to claim 14, wherein the control unit further executes permitting exchange of messages between the user terminal of the first user and the user terminals of the one or more second users after the plan of the predetermined activity is validated.

16. The information processing device according to claim 9, wherein the control unit further executes:
for the disclosed plan of the predetermined activity, receiving, from a user terminal of a fourth user, a participation request that shows that the fourth user desires to participate as a staff member; and
determining that the predetermined activity is to take place and making a disclosure to that effect, when the number of fourth users reaches a predetermined number for the disclosed plan of the predetermined activity, and determining that the predetermined activity is canceled and making a disclosure to that effect, when the number of fourth users falls short of the predetermined number.

17. A program that causes a computer to execute:
receiving an input of a disclosure request that is a request for disclosure of information about a plan of a predetermined activity to be hosted by a first user, and an input of designation of one or more second users among a plurality of users as receivers of a request to participate in running the predetermined activity; and
sending the disclosure request and identification information on the one or more second users to a predetermined server,
wherein the predetermined server executes:
disclosing the information about the plan of the predetermined activity on a first website; and
sending a request to participate in running the predetermined activity to user terminals of the one or more second users.

18. The program according to claim 17, wherein any user among the users is able to be designated as one of the one or more second users.

19. The program according to claim 17,
wherein the program causes the computer to further execute:
receiving an input of resource information that includes a place, an object, and a thing relating to interests and concerns of the first user and to skills that the first user is able to offer, and an input of a registration request that is a request for registration of the resource information; and
sending the registration request and the resource information to the predetermined server,
wherein the predetermined server further executes:
holding the resource information in a storage unit as one piece of user information on the first user; and
disclosing the resource information on the first website, and
wherein the information about the plan of the predetermined activity includes at least one piece of the resource information connected with the first user.

20. The program according to claim 19,
wherein the program causes the computer to further execute:
receiving an input of specification of first resource information disclosed about another user, and an input of a recording request that is a request for recording of the specified first resource information; and
sending the recording request and the first resource information to the predetermined server, and
wherein the predetermined server further executes recording the user information on the first user and the first resource information in the storage unit so as to be connected with each other.
